(19) United States
(12) Patent Application Publication
(10) Pub. No.: US 2011/0007516 A1
(43) Pub. Date: Jan. 13, 2011

(54) TRUCK REAR LAMP

(76) Inventors: Hsi-Hsien Tsai, Tainan City (TW); Chi-Kang Lei, Yongkang City (TW)

Correspondence Address: Hsi-Hsien TSAI, P.O. BOX 90, Tainan City, 70499, TW

(21) Appl. No.: 12/499,095

(22) Filed: Jul. 8, 2009

(51) Int. Cl. B60Q 1/00

(52) U.S. Cl. 362/485

(57) ABSTRACT

A truck rear lamp includes a housing, a unitary circuit board, a main lamp shell, a side lamp shell and a license-plate lamp shell combined together. The circuit board has a front side provided with plural main LEDs and a rear side fixed with a connecting seat having an outer end disposed with a side LED, further having plural license plate LEDs arranged at a location near the bottom of a rear side, and the license plate LEDs has one side provided with a reflecting mirror. The unitary circuit board received in the housing is installed thereon with LEDs respectively located at different locations for carrying out different-purpose lighting and warning, able to save time and labor in assembly and lower producing cost.

### BACKGROUND OF THE INVENTION

1. Field of the Invention

This invention relates to a truck rear lamp, particularly to one having a base provided therein with a unitary circuit board disposed thereon with LEDs respectively located at different regions for carrying out different purposes of lighting and warning, able to save time and labor in assembly and lower producing cost.

2. Description of the Prior Art

A first conventional truck rear lamp, as disclosed in a U.S. Pat. No. 5,934,798, can only be used for illuminating the license plate of a truck, but cannot be used as a brake lamp or a side marker lamp. A second conventional truck rear lamp, as disclosed in another U.S. Pat. No. 6,533,445 B1, titled “VEHICLE LIGHT”, is to have light source (LEDs) and a circuit module connected between a first light shell and a second light shell. The first array of LEDs on the circuit module are arranged side by side and aimed at a tail light shell and connected to a first printed circuit board, while the second array of LEDs on the circuit module are aimed at a side light shell and connected to a second printed circuit board, and the circuit module has a third array of LEDs aimed at a license-plate light shell and connected to a third printed circuit board. The first, the second and the third printed circuit board are connected to conductors for connecting light assembly to the vehicle lights through a vehicle electric system. However, in the structure of the second conventional vehicle light, different printed circuit boards and LEDs have to be respectively disposed at a corresponding location of a tail light shell, a side light shell and a license-plate light shell for carrying out different-purpose lighting. In other words, LEDs with different uses have to be respectively installed on three printed circuit boards that are to be respectively assembled at a location in a first light shell and in a second light shell for attaining different purposes of warning, thus troublesome in producing and assembling the components of vehicle lights and high in producing cost.

### SUMMARY OF THE INVENTION

The objective of this invention is to offer a truck rear lamp, including a HOUSING provided in the interior with a unitary circuit board disposed thereon with LEDs respectively located at different regions for performing different purposes of lighting and warning, saving time and labor in assembly and reducing producing cost.

The truck rear lamp in the present invention includes a housing, a unitary circuit board, a main lamp shell, a side lamp shell and a license-plate lamp shell combined together.

The housing is formed with a main accommodating chamber in the interior, having one sidewall provided with a side lamp seat disposed therein with a side accommodating chamber having an inside bored with a side through hole communicating with the main accommodating chamber. The housing is further formed with an open front side and a large hole at the bottom side.

The circuit board received in the main accommodating chamber of the housing has a front side arranged thereon with a plurality of main LEDs and a rear side fixed with a connecting seat having an outer end installed with a side LED. The circuit board is further disposed with plural license plate LEDs at a location near the bottom and has a reflecting mirror positioned at one side of the license plate LEDs.

The main lamp shell is assembled on the front side of the housing.

The side lamp shell is positioned on the side lamp seat of the housing.

The license-plate lamp shell is mounted on the large hole of the bottom side of the housing.

### BRIEF DESCRIPTION OF DRAWINGS

This invention will be better understood by referring to the accompanying drawings, wherein:

FIG. 1 is an exploded perspective view of a truck rear lamp in the present invention;

FIG. 2 is an exploded perspective view of the truck rear lamp and a license plate to be assembled together in the present invention;

FIG. 3 is a perspective view of the truck rear lamp assembled on the license plate in the present invention;

FIG. 4 is a side cross-sectional view of the truck rear lamp in the present invention;

FIG. 5 is an upper cross-sectional view of the truck rear lamp in the present invention; and

FIG. 6 is a schematic view of the truck rear lamp assembled on a truck for use in the present invention.

### DETAILED DESCRIPTION OF THE PREFERRED EMBODIMENT

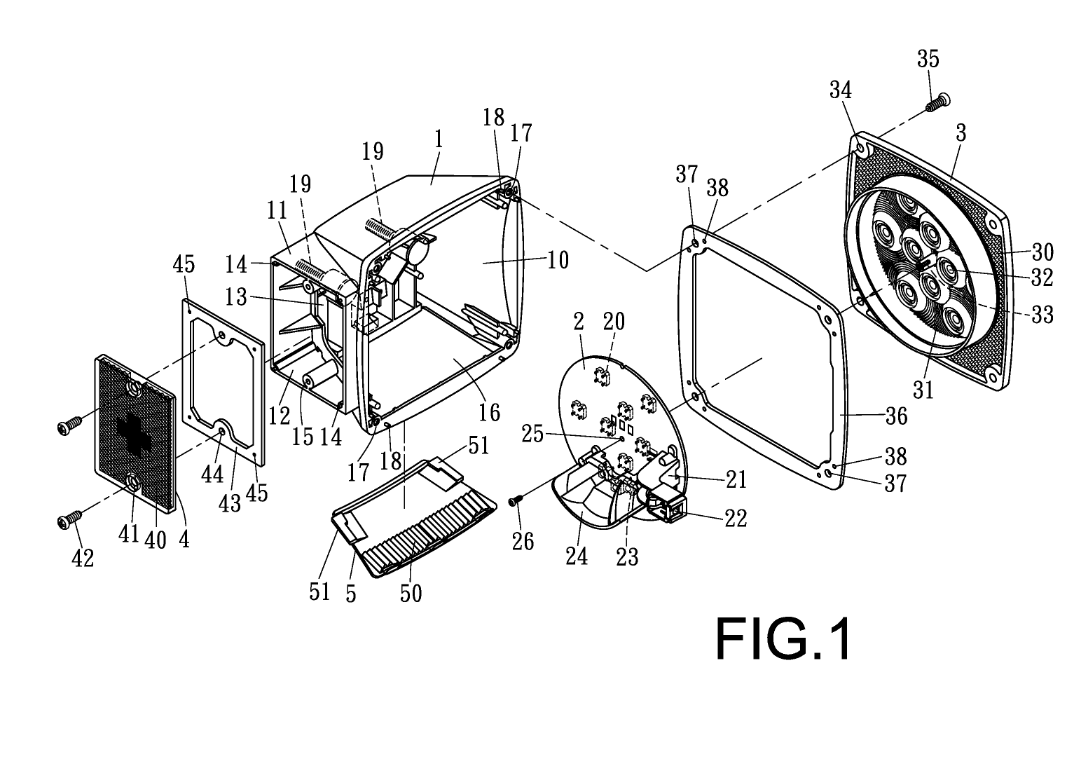

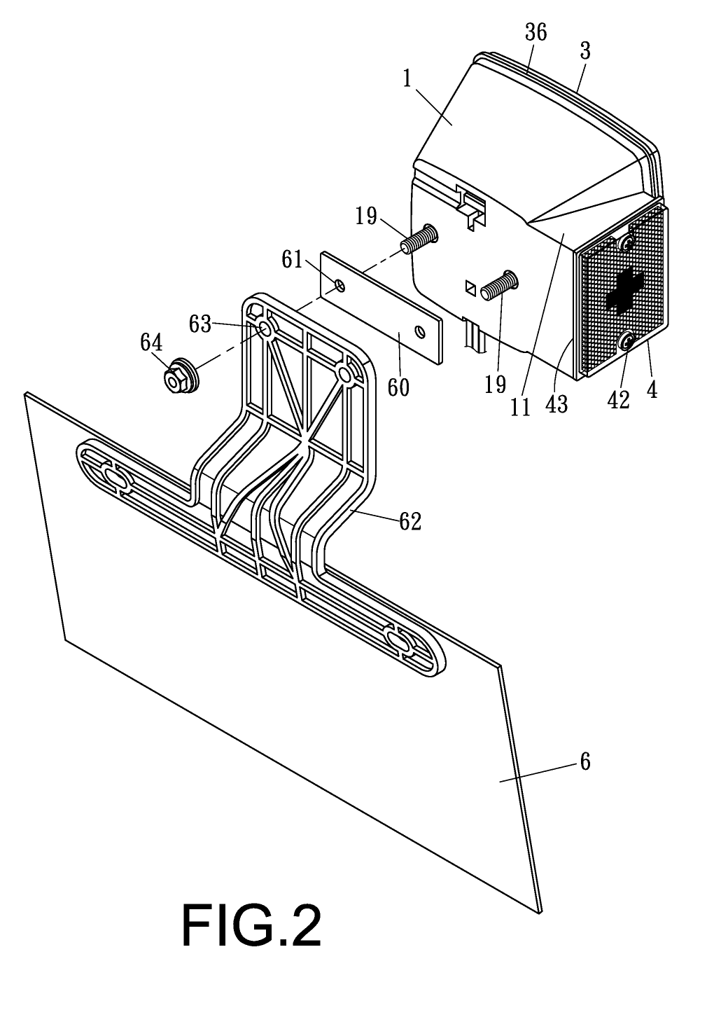

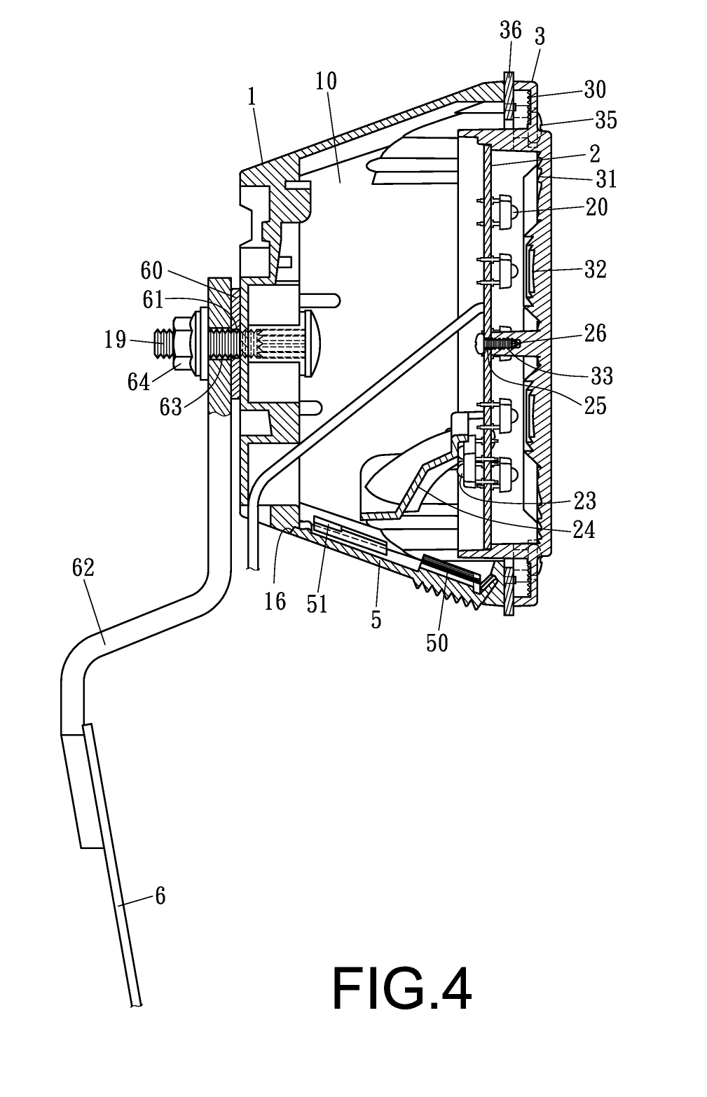

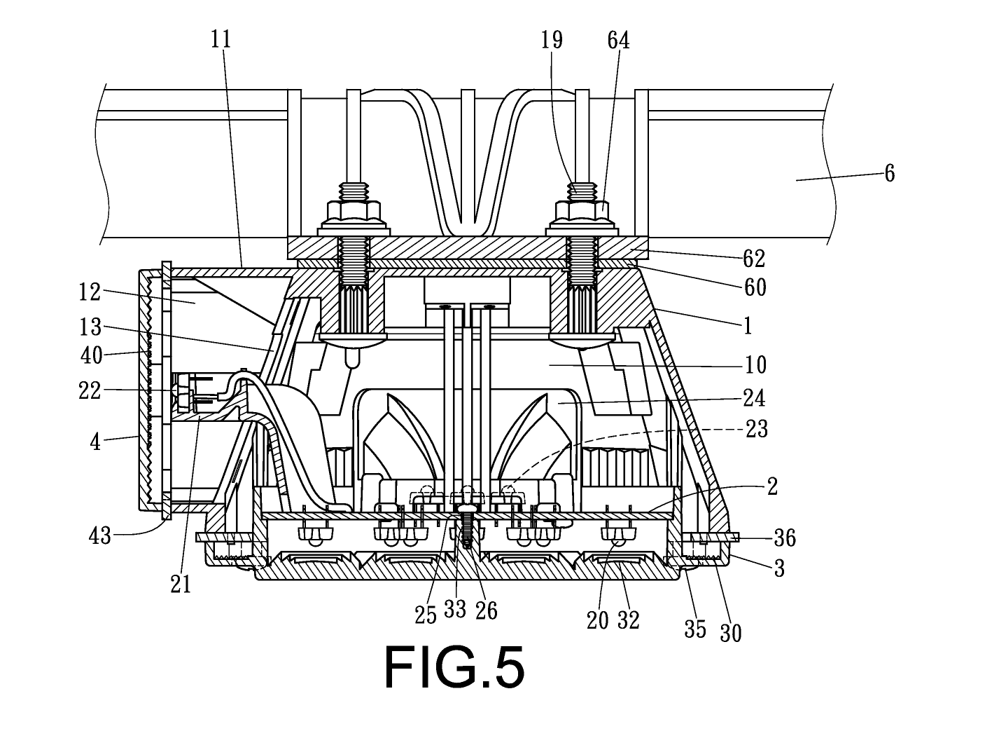

A preferred embodiment of a truck rear lamp in the present invention, as shown in FIGS. 1, 2, 4 and 5, includes a base 1, a unitary circuit board 2, a main lamp shell 3, a side lamp shell 4 and a license-plate lamp shell 5 combined together.

The housing 1 is provided with a main accommodating chamber 10 in the interior and has one sidewall formed integral with a side lamp seat 11 having a side accommodating chamber 12 and bored inside with a side through hole 13 communicating with the main accommodating chamber 10. The side lamp seat 11 further has four corners respectively fixed thereon with a positioning stud 14 and two sides respectively and oppositely bored with a threaded hole 15. In addition, the housing 1 is formed with a large hole 16 at the bottom side, having four corners of an open front side respectively bored with a threaded hole 17 and two positioning studs 18 and also having a rear sidewall secured with two threaded bolts 19.

The circuit board 2 to be received in the main accommodating chamber 10 of the housing 1 has a front side installed thereon with a plurality of main LEDs 20 and a rear side fixed with an L-shaped connecting seat 21 having an outer end provided with a side LED 22. The circuit board 2 has the rear side disposed with a plurality of license-plate LEDs 23 located near the bottom and having one side set with a reflecting mirror 24, further bored with a central insert hole 25 having a fastener 26 inserted therein.

The main lamp shell 3 to be mounted on the open front side of the housing 1 has a rear side formed with numerous cubic reflecting surfaces 30 and provided with a circular refracting plate 31 having a rear side arranged with refracting patterns 32 at locations corresponding with each main LED of the circuit board 2, and the refracting plate 31 is bored with a threaded hole 33 in the center. Further, the main lamp shell 3 has four corners respectively bored with an insert hole 34 having a fastener 35 inserted therein. A water-proof gasket 36 is to be sandwiched between the main lamp shell 3 and the front side of the base 1, provided with a through hole 37 and two position holes 38 at four corners respectively.

The side lamp shell 4 to be positioned on the side lamp seat 11 of the housing 1 has an inner side formed with reflecting surfaces 40 and two sides respectively and oppositely bored with an insert hole 41 inserted therein with a fastener 42. A water-proof gasket 43 is positioned between the side lamp seat 11 and the side lamp shell 4, having two sides respectively and oppositely bored with an insert hole 44 and four corners respectively disposed with a positioning fitting hole 45.

The license-plate lamp shell 5 is to be assembled on the large hole 16 of the bottom side of the housing 1, provided thereon with refracting patterns 50 and having two sides respectively fixed thereon with a projecting fitting member 51.

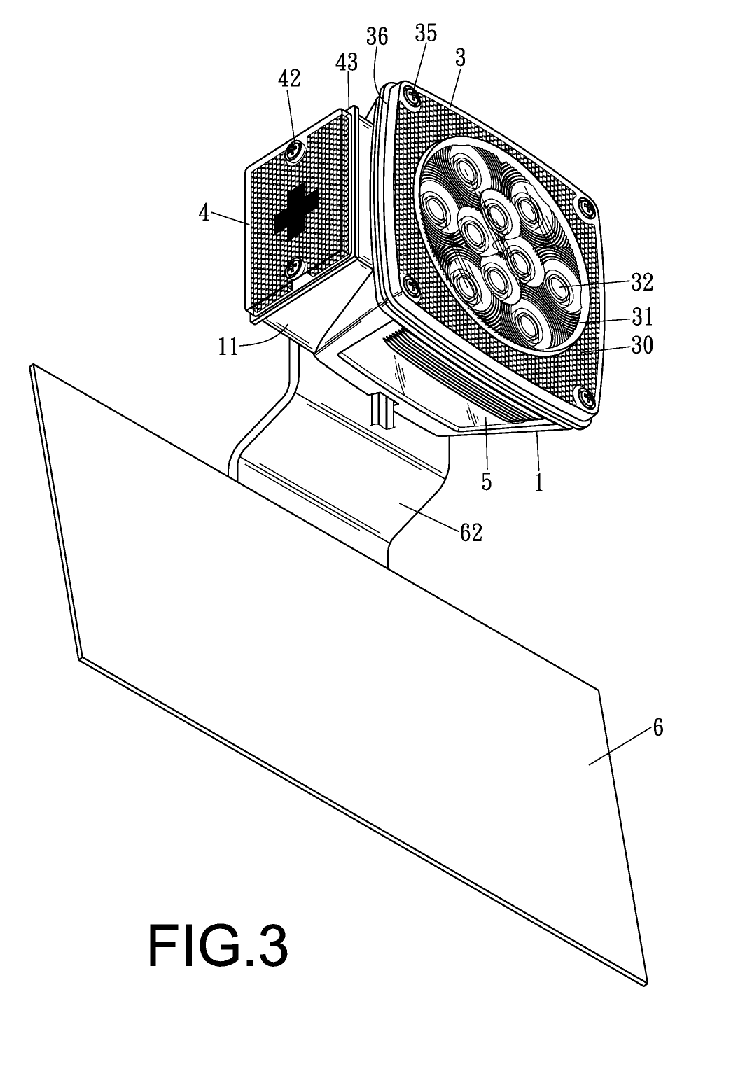

In assembling, referring to FIGS. 1 to 5, firstly, the circuit board 2 is assembled at the inner side of the main lamp shell 3 by means of the fastener 26 that is inserted through the insert hole 25 of the circuit board 2 and screwed in the threaded hole 33 of the main lamp shell 3. Next, the water-proof gasket 36 is placed on the housing 1, letting the positioning studs 18 on the base 1 respectively inserted in the position holes 38 of the water-proof gasket 36 to secure the water-proof gasket 36 on the base 1, and then the main lamp shell 3 is mounted on the housing 1, letting the circuit board 2 positioned in the main accommodating chamber 10 of the housing 1. Then the connecting seat 21 on the circuit board 2 is made to extend into the side accommodating chamber 12 through the side through hole 13. Subsequently, the main lamp shell 3 is fixed on the housing 1 by means of the fasteners 35 that are respectively inserted through the insert holes 34 of the main lamp shell 3 and the through holes 37 of the water-proof gasket 36 and then screwed in the threaded holes 17 of the housing 1. Afterward, the water-proof gasket 43 of the side lamp shell 4 is assembled on the side lamp seat 11, letting the positioning studs 14 on the side lamp seat 11 respectively inserted in the positioning fitting holes 45 of the water-proof gasket 43 to fix the water-proof gasket 43 on the side lamp seat 11. Then, the side lamp shell 4 is firmly mounted on the side lamp seat 11 by the fasteners 42 respectively inserted through the insert holes 41 of the side lamp shell 4 and the insert holes 44 of the water-proof gasket 43 and screwed in the threaded holes 15 of the side lamp seat 11. Lastly, the license-plate lamp shell 5 is fitted in the large hole 16 of the bottom side of the housing 1 to have the engage members 51 of the license-plate lamp shell 5 fitted in the inner side of the main accommodating chamber 10 of the base 1, thus finishing assembling a truck rear lamp.

To have a license plate 6 combined with the truck rear lamp, a back-up plate 60 has to be first set at the rear side of the housing 1 to have the threaded bolts 19 of the base 1 respectively inserted through the insert holes 61 of the back-up plate 60 and the insert holes 63 of a license-plate bracket 62 of the license plate 6 and then locked by a locking nut 64, convenient and quick in assembly.

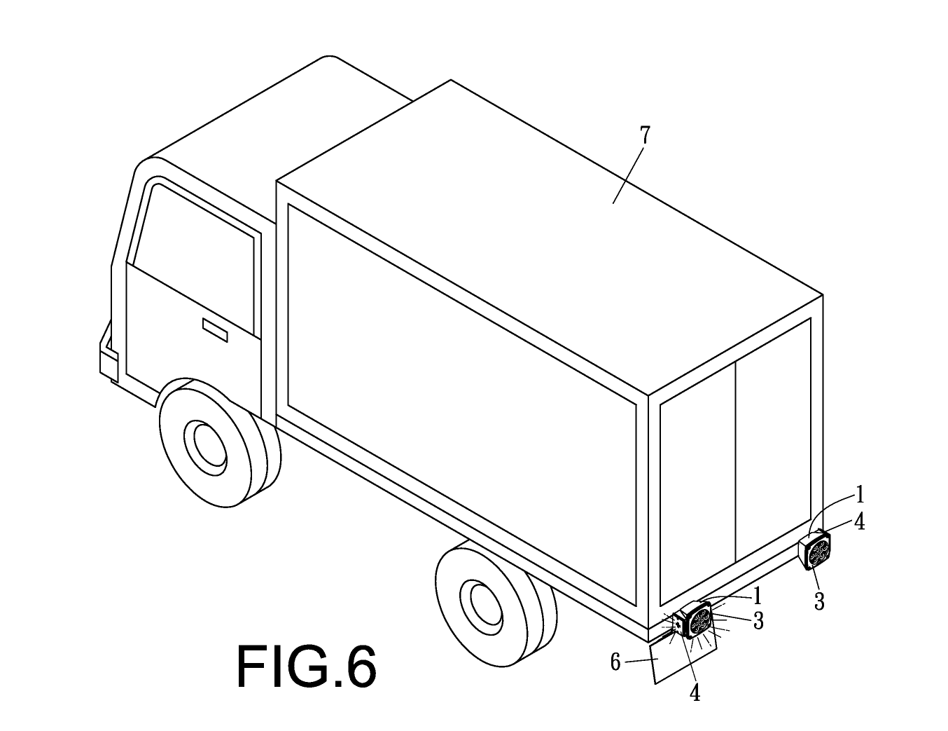

In using, referring to FIG. 6, the truck rear lamp combined with the license plate 6 is assembled at two rear sides of a truck 7. When the head lamp of the truck 7 is switched on, the main LEDs 20 on the circuit board 2 will shine and shoot light out through the main lamp shell 3 for warning vehicles coming from behind. Simultaneously, the license-plate LED 23 at the rear side of the circuit board 2 will also shine and transmit light out through the license-plate lamp shell 5 for illuminating the license plate 6, and the side LEDs 22 on the connecting seat 21 of the circuit board 2 will shine at the same time and the light of the side LEDs will be refracted out through the side lamp shell 4 for carrying out side warning.

Specifically, the truck rear lamp of this invention is provided with the unitary circuit board 2 disposed thereon with LEDs that are respectively installed at different regions for carrying out lighting and warning of different purposes, able to economize time and labor in assembly and reduce producing cost.

While the preferred embodiment of the invention has been described above, it will be recognized and understood that various modifications may be made therein and the appended claims are intended to cover all such modifications that may fall within the spirit and scope of the invention.

What is claimed is:

1. A truck rear lamp comprising:
a housing formed with a main accommodating chamber in an interior, said housing provided with a side lamp seat at one sidewall, said side lamp seat formed in an interior with a side accommodating chamber bored inside with a side through hole communicating with said main accommodating chamber, said housing formed with an open front side and a large hole in a bottom side;
a circuit board received in said main accommodating chamber of said housing, said circuit board having a front surface installed thereon with a plurality of LEDs and a rear side fixed with a connecting seat, said connecting seat having an outer end provided with a side LED, said circuit board arranged with a plurality of license-plate LEDs at a location near a bottom of a rear side, said license-plate LEDs having one side assembled with a reflecting mirror;
a main lamp shell mounted on the front side of said housing;
a side lamp shell assembled on said side lamp seat of said housing; and
a license-plate lamp shell set on said opening at the bottom of said housing.

2. The truck rear lamp as claimed in claim 1, wherein said base has four corners of the front side respectively disposed with a threaded hole, and four corners of said main lamp shell are respectively bored with an insert hole inserted therein with a fastener, said fastener screwed in said threaded holes at the front side of said housing.

3. The truck rear lamp as claimed in claim 1, wherein said side lamp seat is bored with two opposite threaded holes, and said side lamp shell is formed with two opposite insert holes respectively having a fastener inserted therein, said fastener screwed in said threaded hole of said side lamp shell.

4. The truck rear lamp as claimed in claim 1, wherein said housing is fixed with two fasteners at the rear side for combining a license plate.

5. The truck rear lamp as claimed in claim 1, wherein said circuit board is bored with an insert hole, and said main lamp shell is bored with a threaded hole in a center, a fastener inserted through said insert hole of said circuit board and screwed in said threaded hole of said main lamp shell.

6. The truck rear lamp as claimed in claim 1, wherein said main lamp shell is provided inside with a refracting plate having an inner side disposed with refracting patterns at locations respectively corresponding with each said main LED of said circuit board.

7. The truck rear lamp as claimed in claim 1, wherein a water-proof gasket is sandwiched between said main lamp shell and said housing.

8. The truck rear lamp as claimed in claim 1, wherein a water-proof gasket is positioned between said side lamp seat and said side lamp shell.

9. The truck rear lamp as claimed in claim 1, wherein said license-plate lamp shell has two sides respectively provided with a projecting fitting member.
